(19) United States
(12) Patent Application Publication
(10) Pub. No.: US 2008/0042542 A1
(43) Pub. Date: Feb. 21, 2008

(54) ELECTRON EMISSION DEVICE, MANUFACTURING METHOD OF THE DEVICE

(76) Inventors: Sam-Il Han, Yongin-si (KR); Sang-Hyuck Ahn, Yongin-si (KR); Sang-Jo Lee, Yongin-si (KR); Sang-Ho Jeon, Yongin-si (KR); Jin-Hui Cho, Yongin-si (KR); Su-Bong Hong, Yongin-si (KR)

Correspondence Address: CHRISTIE, PARKER & HALE, LLP, PO BOX 7068, PASADENA, CA, 91109-7068, US

(21) Appl. No.: 11/694,804

(22) Filed: Mar. 30, 2007

(30) Foreign Application Priority Data
Jun. 19, 2006 (KR) 10-2006-0054921

(51) Int. Cl. H01J 63/04

(52) U.S. Cl. 313/364; 313/496; 445/1

(57) ABSTRACT

An electron emission device includes a substrate, cathode electrodes and gate electrodes formed on the substrate crossing one another to thereby form a plurality of crossed regions, and electron emission regions, each electrically coupled to one of the cathode electrodes. Each of the cathode electrodes includes a resistive layer formed with first openings, and a conductive layer disposed on one surface of the resistive layer, and formed with second openings. The second openings are spatially communicated respectively with the first openings, and circumferential wall portions of the conductive layer defining the second openings maintain a predetermined spacing from circumferential wall portions of the resistive layer defining the first openings. The electron emission regions are then disposed in the first openings.

### CROSS-REFERENCE TO RELATED APPLICATION

This application claims priority to and the benefit of Korean Patent Application No. 10-2006-54921 filed on Jun. 19, 2006 in the Korean Intellectual Property Office, the entire content of which is incorporated herein by reference.

### BACKGROUND OF THE INVENTION

1. Field of the Invention

The present invention relates to an electron emission device having a cathode electrode on which a resistance layer is disposed to increase an electron emission uniformity of the electron emission device. The present invention relates also to a manufacturing method of the electron emission device and to a light emission device using the electron emission device.

2. Description of Related Art

There are many different types of light emission devices that radiate visible light. One type of light emission device includes a structure in which electron emission elements are disposed on a first substrate, and a phosphor layer and an anode electrode are disposed on a second substrate that faces the first substrate. Electrons emitted from the electron emission elements excite the phosphor layer to cause the same to emit visible light.

In the above type of light emission device, the first and second substrates are interconnected using a sealing member, and the air within a space between the first and second substrates is removed so as to form a vacuum vessel. The electron emission elements may be of the field emission array (FEA) type, and are arrayed on the first substrate to form an electron emission device with the first substrate.

The FEA-type of electron emission element includes electron emission regions, and cathode and gate electrodes functioning as driving electrodes. The electron emission regions are formed utilizing a material having a relatively low work function or a relatively large aspect ratio, such as a carbon-based material, so as to emit electrons when an electric field is formed around the electron emission regions under a vacuum atmosphere.

During operation of the light emission device, a drop in voltage may occur as a result of an unstable driving voltage being applied to the driving electrodes or due to an internal resistance of the driving electrodes. This may result in unintentional differences in voltages applied to the electron emission regions. When this occurs, the emission characteristics of the electron emission regions become uneven, thereby resulting in deterioration in the illumination uniformity of the pixels.

To solve this problem, apertures are formed within the cathode electrodes, and isolation electrodes are disposed within the apertures. Resistive layers are formed between the cathode electrodes and the isolation electrodes. Electron emission regions are formed on the isolation electrodes. With this configuration, as a result of receiving a stabilized current through the resistive layers, uniformity of the emission characteristics of the electron emission regions is achieved.

However, in the above cathode electrode structure, due to the arrangement of the isolation electrodes and the resistive layers, the degree of integration of the electron emission regions is lowered. This makes it difficult for a sufficient amount of electrons to be supplied to each of the pixels, thereby resulting in a drop in screen brightness. Further, as a result of the apertures, the effective width through which current actually flows in the cathode electrodes is reduced thereby, causing a sharp drop in voltage.

In addition, in the above structure of the cathode electrodes, separate exposure masks are typically used in photolithography for patterning the cathode electrodes, isolation electrodes, and resistive layers. However, during manufacture, alignment errors may result among the cathode electrodes, isolation electrodes, and resistive layers. In this case, contact defects may occur between the resistive layers and the cathode electrodes, as well as between the resistive layers and the isolation electrodes, such that the flow of current to the electron emission regions may be cut off.

### SUMMARY OF THE INVENTION

Exemplary embodiments of the present invention provide an electron emission device, in which a degree of integration of electron emission regions is increased while providing resistive layers on cathode electrodes to thereby enhance electron emission of each pixel, and an effective width of the cathode electrodes is increased to prevent a drop in voltage.

Exemplary embodiments of the present invention also provide an electron emission device in which alignment error between the cathode electrodes and resistive layers is minimized to prevent product defects and increase pattern precision, and the number of exposure masks used during manufacture of the cathode electrodes is reduced to thereby simplify manufacturing processes. Exemplary embodiments of the present invention also provide a manufacturing method of the electron emission device and a light emission device using the electron emission device.

In an exemplary embodiment of the present invention, an electron emission device includes a substrate, cathode electrodes and gate electrodes formed on the substrate crossing one another to thereby form a plurality of crossed regions, and electron emission regions, each electrically coupled to a respective one of the cathode electrodes, wherein each of the cathode electrodes includes a resistive layer formed with first openings, and a conductive layer disposed on one surface of the resistive layer and formed with second openings, the second openings being spatially communicated respectively with the first openings, wherein circumferential wall portions of the conductive layer defining the second openings maintain a predetermined spacing from circumferential wall portions of the resistive layer defining the first openings, and wherein the electron emission regions are disposed in the first openings.

The second openings may be larger than the first openings, and central axes of the second openings may be substantially aligned with central axes of the first openings respectively. At each of the crossed regions of the cathode electrodes and the gate electrodes, at least one row of pairs of the first and second openings may be formed along a lengthwise direction of the cathode electrodes. The conductive layers may be disposed farther away from the substrate than the resistive layers. Alternatively, the resistive layers may be disposed farther away from the substrate than the conductive layers.

The electron emission device may further include a focusing electrode disposed above the cathode electrodes and the gate electrodes.

In another exemplary embodiment of the present invention, a light emission device includes first and second substrates disposed facing one another, cathode electrodes and gate electrodes formed on an inner surface of the first substrate crossing one another to form a plurality of crossed regions, electron emission regions, each electrically coupled to one of the cathode electrodes, and a phosphor layer disposed on an inner surface of the second substrate, wherein each of the cathode electrodes includes a resistive layer formed with first openings, and a conductive layer disposed on one surface of the resistive layer and formed with second openings, the second openings being spatially communicated respectively with the first openings, wherein circumferential wall portions of the conductive layer defining the second openings maintain a predetermined spacing from circumferential wall portions of the resistive layer defining the first openings, and wherein the electron emission regions are disposed in the first openings.

The second openings may be larger than the first openings, and central axes of the second openings may be substantially aligned with central axes of respective first openings.

In still another exemplary embodiment of the present invention, a method of manufacturing an electron emission device having a substrate includes (i) sequentially forming a resistive layer and a conductive layer on an entire surface of the substrate, (ii) patterning the conductive layer to form conductive layers in a stripe shape and forming second openings in the conductive layers, (iii) patterning the resistive layer to form resistive layers in a stripe shape and forming first openings in the restive layers, (iv) enlarging the second openings, (v) forming an insulation layer and gate electrodes on the substrate, and forming third openings and fourth openings in the gate electrodes and the insulation layer, respectively, and (vi) forming electron emission regions in the first openings.

The first openings and the second openings may be cylindrical in shape, and central axes of the first openings may be spaced apart from central axes of the second openings by a distance equal or less than 0.5 μm. The enlarging of the second openings may be performed by over-etching using a conductive layer etchant.

In still yet another exemplary embodiment of the present invention, a method of manufacturing an electron emission device having a substrate includes (i) sequentially forming a conductive layer and a resistive layer on an entire surface of the substrate, (ii) patterning the resistive layer to form resistive layers in a stripe shape and forming first openings in the resistive layers, (iii) patterning the conductive layer to form conductive layers in a stripe shape and forming second openings in the conductive layers, each of the second openings having a width greater than that of the corresponding first opening, (iv) forming an insulation layer and gate electrodes on the substrate forming third openings and fourth openings in the gate electrodes and the insulation layer, respectively, and (v) forming electron emission regions in the first openings.

The first openings and the second openings may be cylindrical in shape, and central axes of the first openings may be spaced apart from central axes of the second openings by a distance equal or less than 0.5 μm. The forming of the second openings may be performed by over-etching using a conductive layer etchant.

### BRIEF DESCRIPTION OF THE DRAWINGS

FIG. 1 is a partial exploded perspective view of a light emission device according to a first exemplary embodiment of the present invention.

FIG. 2 is a partial sectional view of the light emission device of FIG. 1.

FIG. 3 is a partial plan view of a cathode electrode of the light emission device of FIG. 1.

FIG. 4 is a partial sectional view of a light emission device according to a second exemplary embodiment of the present invention.

FIG. 5 is a partial plan view of a cathode electrode of the light emission device of FIG. 4.

FIG. 6 is a partial sectional view of a light emission device according to a third exemplary embodiment of the present invention.

FIGS. 7A to 7I are partial sectional views illustrating processes for manufacturing the electron emission device of the first exemplary embodiment.

FIGS. 8A to 8D are partial sectional views illustrating processes for manufacturing the electron emission device of the second exemplary embodiment.

### DETAILED DESCRIPTION OF THE EMBODIMENTS

In exemplary embodiments of the present invention, “light emission device” refers to all devices that emit visible light. Accordingly, all displays that display symbols, letters, numbers, and images to transmit information are also encompassed within the meaning of the term light emission device as it is used herein. In addition, light emission device may also refer to light sources that provide light to a non-emissive display panel.

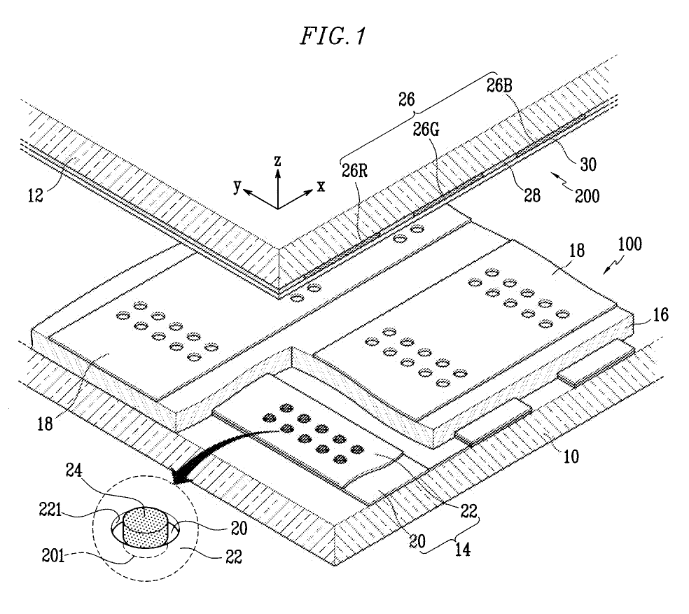

Referring to FIGS. 1-3, a light emission device according to a first exemplary embodiment of the present invention includes a first substrate 10 and a second substrate 12 facing one another in a substantially parallel manner and with a predetermined gap therebetween. A sealing member (not shown) is provided between the first and second substrates 10, 12 along the edge portions thereof to seal together the first and second substrates 10, 12 and thus form a vacuum vessel. In one embodiment, the interior of the vacuum vessel is kept to a degree of vacuum of about 10⁻⁶ Torr.

An electron emission device 100 formed by an array of electron emission elements is provided on a surface of the first substrate 10 facing the second substrate 12. The first substrate 10 having the electron emission device 100 and the second substrate 12 having a light emission unit 200 are combined to form the light emission device.

Cathode electrodes 14 are formed on the first substrate 10 in a stripe pattern and along a first direction (y-direction shown in FIG. 1). An insulation layer 16 is formed on the first substrate 10 covering the cathode electrodes 14, and gate electrodes 18 are formed on the insulation layer 16 in a stripe pattern along a second direction (x-direction shown in FIG. 1) perpendicular to the first direction to thereby cross the cathode electrodes 14.

In this embodiment, each of the cathode electrodes 14 includes a resistive layer 20 having formed therein a plurality of first openings 201 at each region of crossed between the cathode electrodes 14 and the gate electrodes 18, and a conductive layer 22 formed on the resistive layer 20 and having formed therein a plurality of second openings 221 positioned corresponding to the first openings 201 to thereby spatially communicate with the first openings 201.

The second openings 221 have a larger diameter than a diameter of the first openings 201 so as to surround the first openings 201 and in a manner each exposing a predetermined area of the resistive layer 20. Stated differently, circumferential wall portions of the conductive layer 22 defining the second openings 221 maintain a predetermined distance respectively from circumferential wall portions of the resistive layer 20 defining the first openings 201.

Third and fourth openings 181, 161 are formed respectively in the gate electrodes 18 and the insulation layer 16. Each pair of one of the third openings 181 and one of the fourth openings 161 spatially communicates with a respective one of the pairs of one of first openings 201 and one of the second openings 221. Electron emission regions 24 are disposed on the first substrate 10 respectively filling the first openings 201 in the resistive layers 20, such that the electron emission regions 24 are exposed to the second substrate 12.

The second openings 221 in the conductive layer 22 are larger in size than first openings 201 in the resistive layers 20 by a predetermined ratio. One of the second openings 221 and one of the first openings 201 forming each pair of the same have aligned central axes. Accordingly, a predetermined spacing is present between the conductive layer 22 and a circumference of each of the electron emission regions 24.

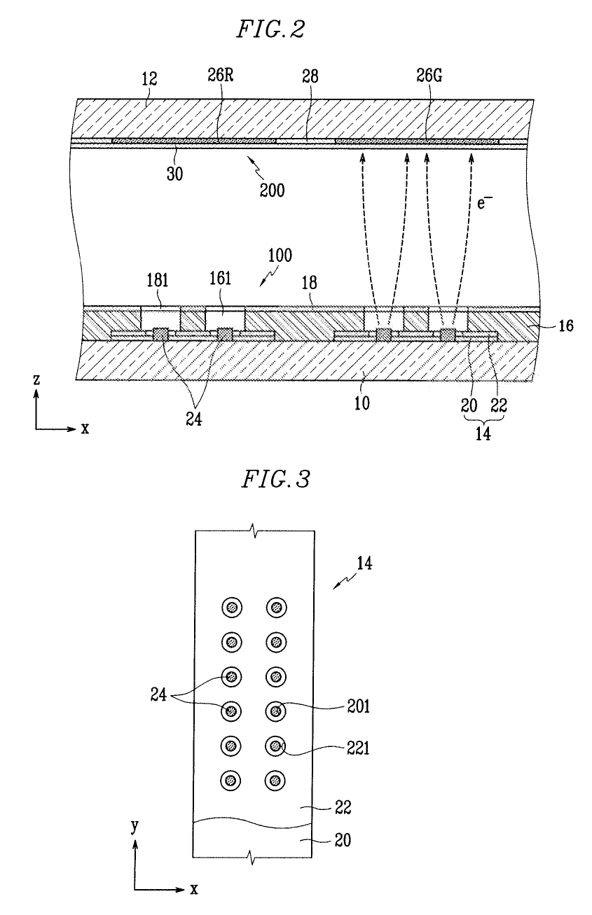

At each of the crossed regions between the cathode electrodes 14 and the gate electrodes 18, one or more rows of the pairs of the first and second openings 201, 221 are formed along the first direction in the resistive layer 20 and the conductive layer 22, respectively. In FIGS. 1 and 3, the first and second openings 201, 221 are shown having a cylindrical shape, and the two such rows of the pairs of the first and second openings 201, 221 are shown formed at each crossed region. However, the shape and arrangement of the first and second openings 201, 221 are not limited to that shown and may be varied as needed.

The resistive layers 20 may be formed by amorphous silicon doped with p- or n-type impurities, and may have a specific resistance of approximately 10,000 to 100,000 Ωcm. The conductive layers 22 are formed by a material having a lower specific resistance than that of the resistive layers 20, for example, a metal material such as chrome, molybdenum, aluminum, or titanium.

The electron emission regions 24 are formed of a material emitting electrons when an electric field is applied thereto under a vacuum atmosphere, such as a carbon-based material or a nanometer-sized material. For example, the electron emission regions 24 may include any one selected from the group consisting of carbon nanotubes, graphite, graphite nanofibers, diamonds, diamond-like carbon, fullerene (C₆₀), silicon nanowires, and any combination thereof. Further, screen-printing, direct growth, chemical vapor deposition (CVD), or sputtering may be used to manufacture the electron emission regions 24.

Phosphor layers 26 (e.g., red, green, and blue phosphor layers 26R, 26G, 26B) are formed on a surface of the second substrate 12 facing the first substrate 10 and in such a manner that a predetermined spacing is provided between adjacent pairs of the phosphor layers 26. A black layer 28 is formed between adjacent pairs of the phosphor layers 26 to enhance screen contrast. The phosphor layers 26 are disposed in such a manner that one of the phosphor layers 26 of a single color corresponds in location to each crossed region of the cathode and gate electrodes 14, 18.

An anode electrode 30 is formed on the phosphor layers 26 and the black layers 28, and is formed by a metal material such as aluminum (Al). The anode electrode 30 is an acceleration electrode that receives a high voltage to maintain the phosphor layers 26 at a high electric potential state, and also functions to enhance luminance by reflecting visible light. That is, among the visible light emitted from the phosphor layers 26, the visible light that is emitted from the phosphor layers 26 toward the first substrate 10 is reflected by the anode electrode 30 toward the second substrate 12.

In some embodiments, the anode electrode 30 may be formed by a transparent conductive material such as indium tin oxide, in which case the anode electrode 30 may be disposed on surfaces of the phosphor layers 26 and the black layers 28 facing the second substrate 12. In other embodiments, the anode electrode 30 may be realized through a structure in which a transparent conductive layer and a metal layer are combined.

A plurality of spacers (not shown) are disposed between the first and second substrates 10 and 12 to resist atmospheric pressure applied to the vacuum vessel to thereby ensure that the gap between the first and second substrates 10 and 12 is uniformly maintained. The spacers are disposed corresponding in position to the black layers 28 so as not to block the phosphor layers 26.

The light emission device is driven by applying predetermined voltages to the cathode electrodes 14, the gate electrodes 18, and the anode electrode 30. For example, either the cathode electrodes 14 or the gate electrodes 18 function as scan electrodes receiving a scan driving voltage, and the other ones of the cathode electrodes 14 or the gate electrodes 18 function as data electrodes receiving a data driving voltage. Further, the anode electrode 30 receives a voltage, for example, a positive direct current voltage of a few hundred to a few thousand volts, required for the acceleration of electron beams.

As a result, electric fields are formed around the electron emission regions 24 at the pixels where a voltage difference between the cathode and gate electrodes 14, 18 is equal to or greater than a threshold value so that electrons are emitted from the electron emission regions 24. The emitted electrons are attracted by the high voltage applied to the anode electrode 30 to thereby collide with and illuminate the phosphor layers 26 of the corresponding pixels.

In the aforementioned driving process, the electron emission regions 24 receive a current required for electron emission from the conductive layers 22 via the resistive layers 20. During this process, the resistive layers 20 function to make uniform the emission characteristics of the electron emission regions 24. Since the conductive layers 22 maintain a predetermined spacing around a circumference of each of the electron emission regions 24 as described above, a predetermined resistance is continuously provided to each of the electron emission regions 24. Hence, the emission uniformity of the electron emission elements 24 is further enhanced.

In the case where the electron emission regions 24 are formed using a screen-printing process, shrinkage in the electron emission regions 24 may occur during the process. This may result in the partial contact of the electron emission regions 24 with the resistive layers 20. However, since a predetermined resistance is provided to the electron emission regions 24 regardless of where such contact with the resistive layers 20 takes place, the emission uniformity of the electron emission elements 24 is not adversely affected.

Further, if the second openings 221 in the conductive layers 22 are formed in a quadrilateral configuration surrounding respectively the first openings 201 in the resistive layers 20, the electron emission regions 24 have different distances from the conductive layers 20 around the circumferences of the electron emission regions 24. Accordingly, depending on where the electron emission regions 24 contact the resistive layers 20, the resistance values provided to the electron emission regions 24 vary to thereby reduce the emission uniformity.

Further, in this embodiment, the cathode electrodes 14 do not include additional isolation electrodes for the mounting of the electron emission regions 24, and the electron emission regions 24 are directly formed on the resistive layers 20. As a result, the electron emission regions 24 may be more precisely mounted, thereby allowing for the increase in the amount of emitted electrons for each pixel and thus enhancing screen luminance.

In addition, in the light emission device of this embodiment, all of the conductive layers 22 may be used as an effective width excluding where the second openings 221 are formed therein. Hence, a drop in voltage of the cathode electrodes 14 is prevented, and the width of the cathode electrodes 14 may be reduced without encountering any significant difficulties, thereby allowing for a high resolution to be achieved.

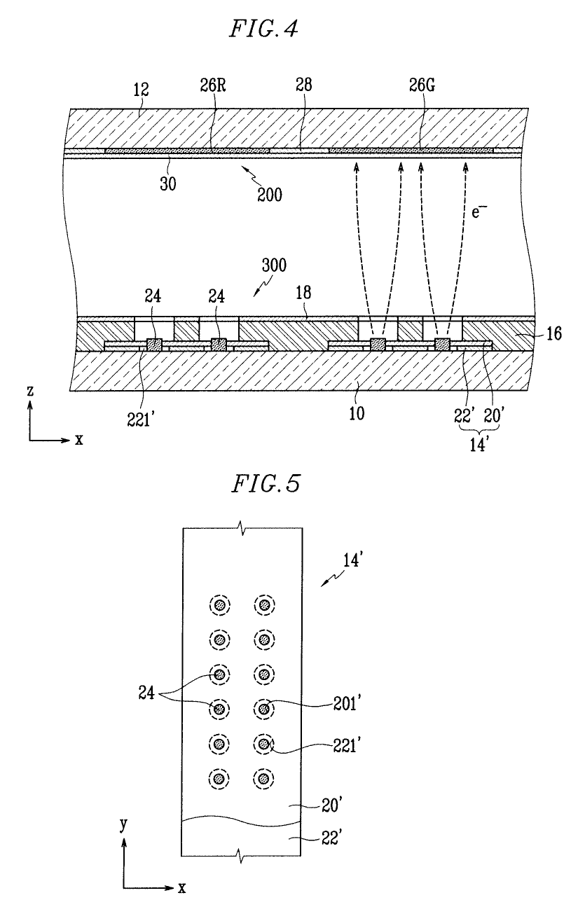

Referring to FIGS. 4 and 5, a light emission device according to a second exemplary embodiment of the present invention will now be described. The light emission device of the second exemplary embodiment has substantially the same configuration as that of the first exemplary embodiment except for the structure described below. In FIG. 4, reference numeral 300 indicates an electron emission device.

With reference to FIGS. 4 and 5, in the light emission device of the second exemplary embodiment, cathode electrodes 14′ have a layered structure different than that of the cathode electrodes 14 (see FIGS. 1-3) of the first exemplary embodiment. That is, conductive layers 22′ having formed therein a plurality of second openings 221′ are disposed on the first substrate 10, and resistive layers 20′ having formed therein a plurality of first openings 201′ are disposed on the conductive layers 22′. A diameter of the first openings 201′ is smaller than a diameter of the second openings 221′.

Further, the electron emission regions 24 contact the corresponding resistive layers 20′ while filling respectively the first openings 201′, and the conductive layers 22′ maintain a predetermined spacing from the circumferences of the corresponding electron emission regions 24.

In this embodiment, the resistive layers 20′ are disposed between the corresponding conductive layers 22′ and the insulation layer 16. Accordingly, when the insulation layer 16 undergoes high-temperature baking, the metal material forming the conductive layers 22′ is prevented from being diffused from the insulation layer 16, thereby preventing a drop in withstanding voltage characteristics of the insulation layer 16 resulting from such diffusion. Except for the structure of the cathode electrodes 14′ as described above, all other aspects of the second exemplary embodiment are similar to the first exemplary embodiment.

Referring to FIG. 6, a light emission device according to a third exemplary embodiment of the present invention will now be described. In FIG. 6, reference numeral 400 indicates an electron emission device.

With reference to FIG. 6, the light emission device according to the third exemplary embodiment includes the same basic structure of the light emission device of the first exemplary embodiment, but further includes a supplementary insulation layer 32 and a focusing electrode 34.

A plurality of fifth openings 341 are formed in the focusing electrode 34 at locations either corresponding to the respective electron emission regions 24, or corresponding to two or more of the respective electron emission regions 24. As an example of the latter case, two of the fifth openings 341 may be formed for each crossed region of the cathode and gate electrodes 14, 18 such that each row of the electron emission regions 24 in the crossed region is exposed by one of the fifth openings 341.

During operation of the light emission device, the focusing electrode 34 receives 0V or a negative direct current voltage of, for example, several tens of volts, required for electron beam focusing. The electrons passed through the fifth openings 341 are focused to a center of a bundle of electron beams. In FIG. 6, reference numeral 321 indicates sixth openings of the supplementary insulation layer 32.

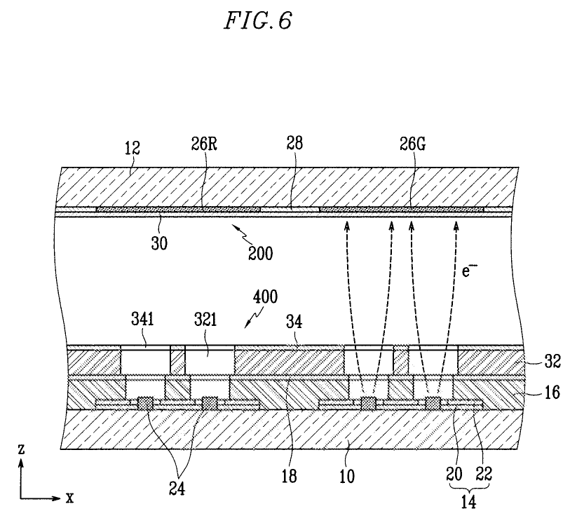

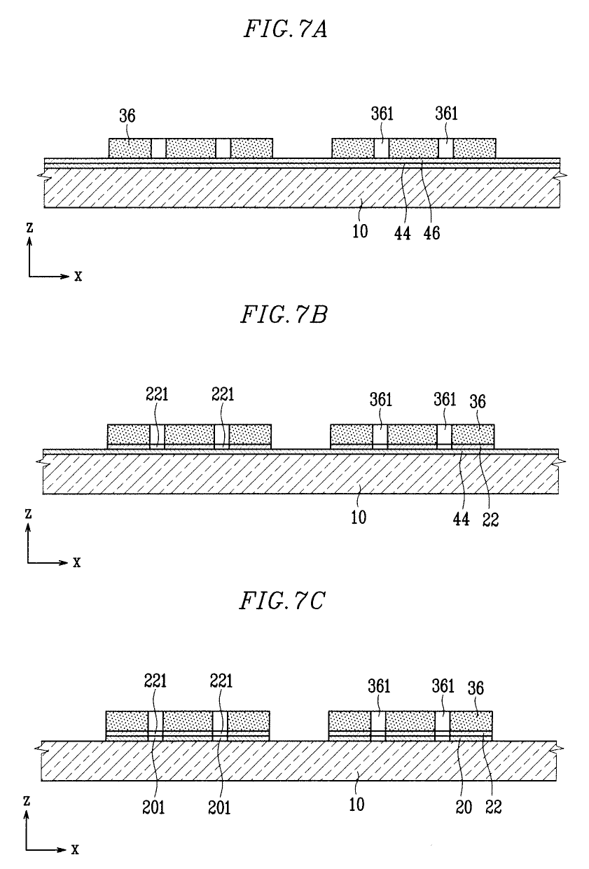

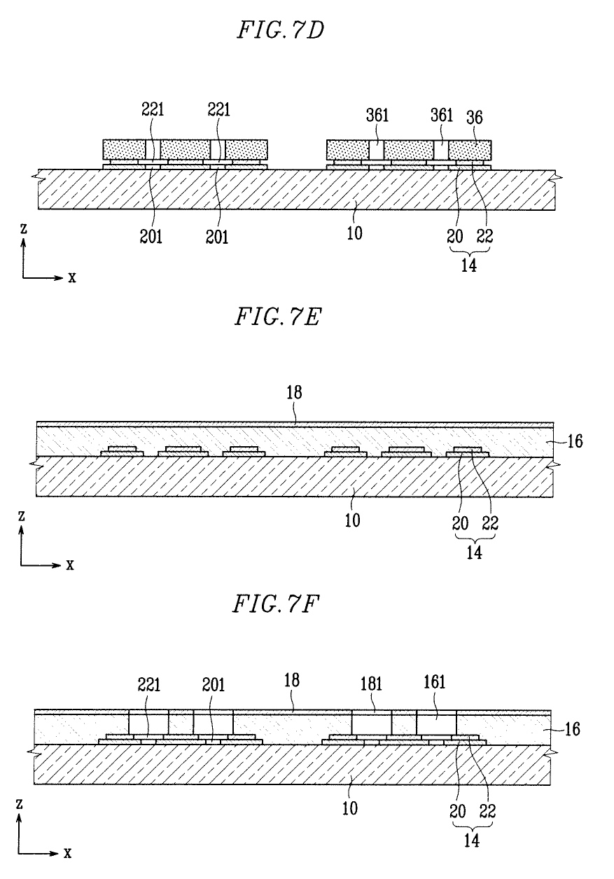

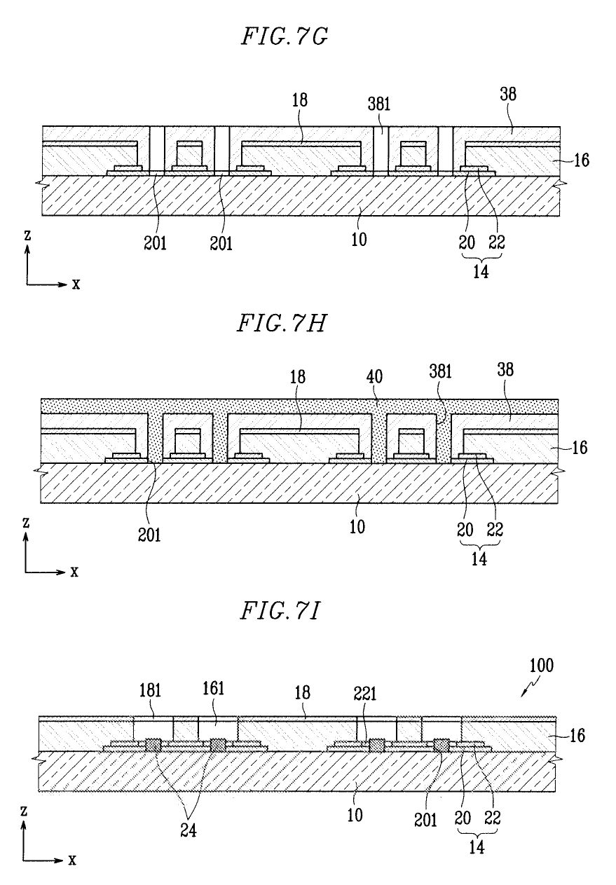

A method of manufacturing the electron emission device 100 of the first exemplary embodiment will now be described. FIGS. 7A to 7I are partial sectional views illustrating processes for the method of manufacturing the electron emission device 100 of the first exemplary embodiment.

Referring to FIGS. 1 and 7A, a resistive material layer 44 is formed on the first substrate 10, and a conductive material layer 46 is coated on the resistive material layer 44. Next, a mask layer 36 is formed on the first substrate 10 covering the conductive material layer 46. The mask layer 36 is then patterned into a stripe configuration, and at the same time, a plurality of seventh openings 361 are formed in the mask layer 36 at locations corresponding to where the electron emission regions are to be formed and sized corresponding to the intended size of the electron emission regions. The mask layer 36 may be formed of a photoresist material.

Referring to FIG. 7B, a first etching process is performed targeting the exposed conductive material layer 46 to thereby form the conductive layers 22 in a stripe pattern and, simultaneously, the second openings 221 in the conductive layers 22. Subsequently, with reference to FIG. 7C, areas of the resistive material layer 44 not covered by the mask layer 36 and the conductive layers 22, i.e., exposed areas of the resistive material layer 44, are etched to thereby form the resistive layers 20 in a stripe pattern and, simultaneously, the first openings 201 in the resistive layers 20.

Referring to FIG. 7D, using a conductive layer etchant, a second etching process is performed on the conductive layers 22, after which the mask layer 36 is removed. As a result, the conductive layers 22 are over-etched such that the second openings 221 in the conductive layers 22 are enlarged and thereby made to be larger than the first openings 201 in the resistive layers 20, thereby exposing predetermined areas of the resistive layers 20 adjacent to the circumferences of the second openings 221.

Although a linewidth of the conductive layers 22 is slightly reduced through the above over-etching process, the functioning of the conductive layers 22 is only minimally affected. Through the above processes, the cathode electrodes 14 formed of the resistive layers 20 and the conductive layers 22 are completed.

Referring to FIG. 7E, an insulation material is deposited to a predetermined thickness on the first substrate 10 covering the cathode electrodes 14 to thereby form the insulation layer 16. A CVD method or a screen-printing method may be used to form the insulation layer 16. A conductive material is then coated on the insulation layer 16 and patterned to thereby form the gate electrodes 18 in a stripe formation crossing the cathode electrodes 14.

Referring to FIG. 7F, the gate electrodes 18 and the insulation layer 16 are sequentially etched using a conventional photolithography process to thereby form the third openings 181 and the fourth openings 161 respectively in the gate electrodes 18 and the insulation layer 16. The third and fourth openings 181, 161 may be formed to be the same size or larger than the second openings 221 in the conductive layers 22.

Referring to FIG. 7G, a sacrificial layer 38 is formed over the entire area of the first substrate 10 and patterned to form eightieth openings 381 of the same size as the first openings 201. The sacrificial layer 38 may be formed of a photoresist material, in which case patterning of the sacrificial layer 38 may be performed by irradiating ultraviolet rays onto a rear surface of the first substrate 10 to thereby selectively expose the sacrificial layer 38 through the first openings 201. The exposed areas are then removed through a developing process.

Referring to FIGS. 7H and 7I, an electron emission material is filled in the first openings 201 to thereby form the electron emission regions 24. This process may be realized through the following steps of: screen printing a paste mixture 40 including an electron emission material and a photosensitive material on the sacrificial layer 38, irradiating ultraviolet light onto the rear surface of the first substrate 10 to thereby harden the mixture 40 filled in the first openings 201, removing through a developing process portions of the mixture 40 not hardened, detaching the sacrificial layer 38, and drying and baking the hardened mixture 40.

The electron emission material may be a material selected from the group consisting of carbon nanotubes, graphite, graphite nanofibers, diamonds, diamond-like carbon, fullerene (C₆₀), silicon nanowires, and a combination thereof. Since the electron emission regions 24 are hardened through a rear-surface exposure process as described above, a high degree of adhesivity with the first substrate 10 is realized. Further, the electron emission regions 24 are electrically coupled to the resistive layers 20 through contact therewith, such that the electron emission regions 24 receive current required for electron emission from the conductive layers 22.

An adhesive tape (not shown) may be attached to the electron emission regions 24 as needed, and through an activation process of stripping off the same, a surface of the electron emission material is exposed to thereby enhance emission efficiency.

In the manufacturing method of the exemplary embodiment described above, the conductive layers 22 and the resistive layers 20 are patterned using one mask layer 36 such that alignment error between the conductive layers 22 and the resistive layers 20 is minimized, thereby preventing the occurrence of resistance value differences in the electron emission regions 24. Further, through use of the one mask layer 36, manufacturing is simplified, ultimately reducing the cost of production.

In addition, through use of the rear-surface exposure process during patterning of the sacrificial layer 38, the eightieth openings 381 are aligned respectively with the first openings 201, thereby resulting in center axes of the electron emission regions 24 corresponding precisely and respectively with center axes of the first openings 201.

Furthermore, although the electron emission regions 24 may shrink during baking to thereby only partially contact the resistive layers 20, through the structure of the cathode electrodes 14, the electron emission regions 24 are provided with a uniform resistance, thereby enhancing the emission uniformity of the electron emission regions 24.

In the electron emission device 100 made using the manufacturing method of the exemplary embodiment, the central axes of the first openings 201 in the resistive layers 20 are spaced apart from the central axes of the second openings 221 in the conductive layers 22 by 0.5 μm or less.

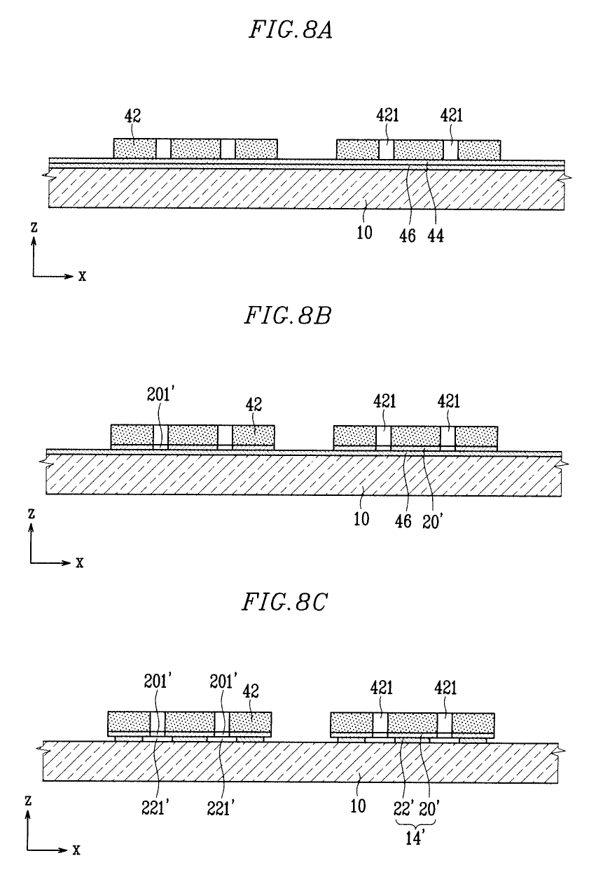

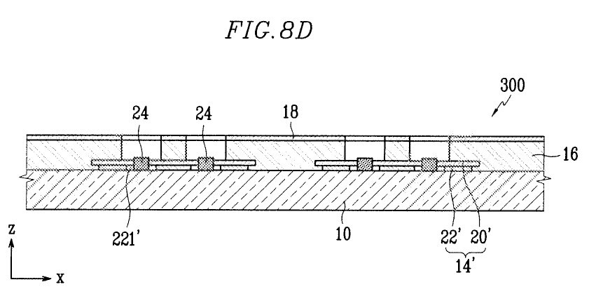

A manufacturing method for an electron emission device according to the second exemplary embodiment of the present invention will now be described. FIGS. 8A to 8D are partial sectional views illustrating processes for manufacturing an electron emission device of the second exemplary embodiment.

Referring to FIGS. 4 and 8A, a conductive material layer 46 is formed on the first substrate 10, and a resistive material layer 44 is formed on the conductive material layer 46. Next, a mask layer 42 is formed on the first substrate 10 covering the resistive material layer 44. The mask layer 42 is then patterned into a stripe configuration and, at the same time, a plurality of ninth openings 421 are formed in the mask layer 42 at locations corresponding to where the electron emission regions are to be formed and sized corresponding to the intended size of the electron emission regions. The mask layer 42 may be formed of a photoresist material.

Referring to FIG. 8B, a first etching process is performed targeting the exposed resistive material layer 44 to thereby form the resistive layers 20′ in a stripe pattern and, at the same time, the first openings 201′ in the resistive layers 20′. Subsequently, with reference to FIG. 8C, areas of the conductive material layer 46 not covered by the mask layer 42 and the resistive layers 20′, i.e., exposed areas of the conductive material layer 46, are over-etched to thereby form the conductive layers 22′ in a stripe pattern and, at the same time, the second openings 221′ in the conductive layers 22′ to a size greater than that of the first openings 201′.

The over-etching of the conductive layers 22′ is performed through a wet-etching process, and the size of the second openings 221′ is controlled by adjusting the etching time. Although a linewidth of the conductive layers 22′ is slightly reduced through the over-etching process, the functioning of the conductive layers 22′ is only minimally affected. Through the above processes, the cathode electrodes 14′ formed of the resistive layers 20′ and the conductive layers 22′ are completed.

The subsequent formation of the insulation layer 16, the gate electrodes 18, and the electron emission regions 24 is similar to that described above with respect to the manufacture of the first exemplary embodiment. The completed electron emission device 300 of the second exemplary embodiment is shown in FIG. 8D.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. An electron emission device, comprising:
a substrate;
cathode electrodes and gate electrodes formed on the substrate crossing one another to thereby form a plurality of crossed regions; and
electron emission regions, each electrically coupled to a respective one of the cathode electrodes,
wherein each of the cathode electrodes includes a resistive layer formed with first openings, and a conductive layer disposed on one surface of the resistive layer and formed with second openings, the second openings being spatially communicated respectively with the first openings, wherein circumferential wall portions of the conductive layer defining the second openings maintain a predetermined spacing from circumferential wall portions of the resistive layer defining the first openings, and
wherein the electron emission regions are disposed in the first openings.

2. The electron emission device of claim 1, wherein the second openings are larger than the first openings, and central axes of the second openings are substantially aligned with central axes of the first openings respectively.

3. The electron emission device of claim 2, wherein at each of the crossed regions of the cathode electrodes and the gate electrodes, at least one row of pairs of the first and second openings is formed along a lengthwise direction of the cathode electrodes.

4. The electron emission device of claim 2, wherein the conductive layers are disposed farther away from the substrate than the resistive layers.

5. The electron emission device of claim 2, wherein the resistive layers are disposed farther away from the substrate than the conductive layers.

6. The electron emission device of claim 1, further comprising a focusing electrode disposed above the cathode electrodes and the gate electrodes.

7. The electron emission device of claim 1, wherein the electron emission regions are formed using a screen-printing process.

8. A light emission device, comprising:
first and second substrates disposed facing one another;
cathode electrodes and gate electrodes formed on an inner surface of the first substrate crossing one another to form a plurality of crossed regions;
electron emission regions, each electrically coupled to one of the cathode electrodes; and
a phosphor layer disposed on an inner surface of the second substrate,
wherein each of the cathode electrodes includes a resistive layer formed with first openings, and a conductive layer disposed on one surface of the resistive layer and formed with second openings, the second openings being spatially communicated respectively with the first openings, wherein circumferential wall portions of the conductive layer defining the second openings maintain a predetermined spacing from circumferential wall portions of the resistive layer defining the first openings, and
wherein the electron emission regions are disposed in the first openings.

9. The light emission device of claim 8, wherein the second openings are larger than the first openings, and central axes of the second openings are substantially aligned with central axes of respective first openings.

10. The light emission device of claim 8, wherein the electron emission regions are formed using a screen-printing process.

11. A method of manufacturing an electron emission device having a substrate, the method comprising:
sequentially forming a resistive layer and a conductive layer on an entire surface of the substrate;
patterning the conductive layer to form conductive layers in a stripe shape and forming second openings in the conductive layers;
patterning the resistive layer to form resistive layers in a stripe shape and forming first openings in the restive layers;
enlarging the second openings;
forming an insulation layer and gate electrodes on the substrate, and forming third openings and fourth openings in the gate electrodes and the insulation layer, respectively; and
forming electron emission regions in the first openings.

12. The method of claim 11, wherein the first openings and the second openings are cylindrical in shape, and central axes of the first openings are spaced apart from central axes of the second openings by a distance equal or less than 0.5 μm.

13. The method of claim 11, wherein the enlarging of the second openings is performed by over-etching using a conductive layer etchant.

14. The method of claim 11, wherein the step of forming the electron emission regions comprises:
forming a sacrificial layer over the entire surface of the substrate and patterning the sacrificial layer to form sacrificial layer openings corresponding to the first openings;
depositing a mixture including an electron emission material and a photosensitive material on the entire surface of the substrate;
irradiating ultraviolet light onto a rear surface of the substrate to selectively harden the mixture filled in the first openings; and
performing developing, drying, and baking.

15. The method of claim 14, wherein the sacrificial layer is formed of a photoresist material, and ultraviolet light is irradiated onto the rear surface of the substrate such that the sacrificial layer is selectively exposed through the first openings.

16. A method of manufacturing an electron emission device having a substrate, the method comprising:
sequentially forming a conductive layer and a resistive layer on an entire surface of the substrate;
patterning the resistive layer to form resistive layers in a stripe shape and forming first openings in the resistive layers;
patterning the conductive layer to form conductive layers in a stripe shape and forming second openings in the conductive layers, each of the second openings having a width greater than that of the corresponding first opening;
forming an insulation layer and gate electrodes on the substrate, and forming third openings and fourth openings in the gate electrodes and the insulation layer, respectively; and
forming electron emission regions in the first openings.

17. The method of claim 16, wherein the first openings and the second openings are cylindrical in shape, and central axes of the first openings are spaced apart from central axes of the second openings by a distance equal or less than 0.5 μm.

18. The method of claim 16, wherein the forming of the second openings is performed by over-etching using a conductive layer etchant.

19. The method of claim 16, wherein the forming of the electron emission regions comprises:
forming a sacrificial layer over the entire surface of the substrate and patterning the sacrificial layer to form sacrificial layer openings corresponding to the first openings;
depositing a mixture including an electron emission material and a photosensitive material on the entire surface of the substrate;
irradiating ultraviolet light onto a rear surface of the substrate to thereby selectively harden the mixture filled in the first openings; and
performing developing, drying, and baking.

20. The method of claim 19, wherein the sacrificial layer is formed of a photoresist material, and ultraviolet light is irradiated onto the rear surface of the substrate such that the sacrificial layer is selectively exposed through the first openings.
